(19) United States
(12) Patent Application Publication
(10) Pub. No.: US 2025/0233356 A1
(43) Pub. Date: Jul. 17, 2025

(54) CONNECTOR

(71) Applicant: Yazaki Corporation, Tokyo (JP)

(72) Inventors: Hiroki KITAGAWA, Shizuoka (JP); Shotaro SHIBATA, Shizuoka (JP); Motohide SATO, Shizuoka (JP); Kengo AOSHIMA, Shizuoka (JP); Takashi ISHIHARA, Shizuoka (JP); Narumi SUZUKI, Shizuoka (JP)

(73) Assignee: Yazaki Corporation, Tokyo (JP)

(21) Appl. No.: 19/011,740

(22) Filed: Jan. 7, 2025

(30) Foreign Application Priority Data
Jan. 17, 2024 (JP) 2024-005088

(51) Int. Cl. H01R 13/627; H01R 13/52

(52) U.S. Cl. CPC H01R 13/627; H01R 13/5213

(57) ABSTRACT

A connector connected to an external connector, comprising: a plurality of terminals; an electric wire lead-out portion for leading out a plurality of electric wires, partially joined to the terminals, in a first direction to be connected to the external connector; and a combination of a first electric wire contact and a second electric wire contact for partially clamping the electric wires extending in a second direction, intersecting with the first direction, between the terminals and the electric wire lead-out portion. The first electric wire contact is integrated with a member having the electric wire lead-out portion.

### CROSS REFERENCE TO RELATED APPLICATION

The present application is based on, and claims priority from the Japanese Patent Application No. 2024-005088, filed on Jan. 17, 2024, the entire contents of which are incorporated herein by reference.

### TECHNICAL FIELD

The present disclosure relates to a connector.

### BACKGROUND

There is a conventionally known connector in which an end of an electric wire to be joined to a terminal is received inside a housing. JP 2022-182738 A discloses a technology related to a connector in which an end of an electric wire, specifically a terminal joint for joining an end of a core wire, is received inside a housing composed of a housing body and a cover. The connector is provided with a gap between the housing body and the electric wire so that the electric wire that is led out from the housing to the outside can follow oscillation of the terminal.

### SUMMARY OF THE INVENTION

The connector disclosed in JP 2022-182738 A does not have a structure to prevent oscillation of the electric wire, although the oscillation of the terminal is absorbed by the electric wire. Therefore, there is a concern that the oscillation of the electric wire caused by some reason is transmitted to an end of the electric wire joined to the terminal, causing an excessive load. On the other hand, for example, it is conceivable to provide a crimping portion or the like on the terminal to prevent oscillation of the electric wire from being transmitted to the end of the electric wire, in addition to a joint for joining the end of the electric wire. However, such a measure is not desirable, since an increase in the size of the terminal, or an increase in the complexity of the structure of the terminal and the connector as a whole, may lead to a decrease in yield rate and an increase in cost.

It is an object of the present disclosure to provide a connector having a simple structure for improving reliability of a joint between a terminal and an electric wire.

An aspect of the present disclosure is a connector connected to an external connector, including a plurality of terminals; an electric wire lead-out portion for leading out a plurality of electric wires, partially joined to the terminals, in a first direction to be connected to the external connector; and a combination of a first electric wire contact and a second electric wire contact for partially clamping the electric wires extending in a second direction, intersecting with the first direction, between the terminals and the electric wire lead-out portion, wherein the first electric wire contact is integrated with a member having the electric wire lead-out portion.

According to the configuration described above, it is possible to provide a connector having a simple structure for improving reliability of a joint between a terminal and an electric wire.

### BRIEF DESCRIPTION OF THE DRAWINGS

FIG. 1 is a perspective view of a connector according to an embodiment.

FIG. 2 is an exploded perspective view of the connector according to an embodiment.

FIG. 3 is a cross-sectional view of the connector cut at a section III-III in FIG. 1.

FIG. 4 is a perspective view of an outer housing according to an embodiment.

FIG. 5 is a perspective view of a rear cover according to an embodiment.

FIG. 6 is a cross-sectional view of the connector cut at a section VI-VI in FIG. 1.

### DETAILED DESCRIPTION OF THE INVENTION

Hereinafter, a connector according to an embodiment will be described in detail with reference to the drawings. Note that the dimensional ratios in the drawings are exaggerated for convenience of explanation and may differ from the actual ratios.

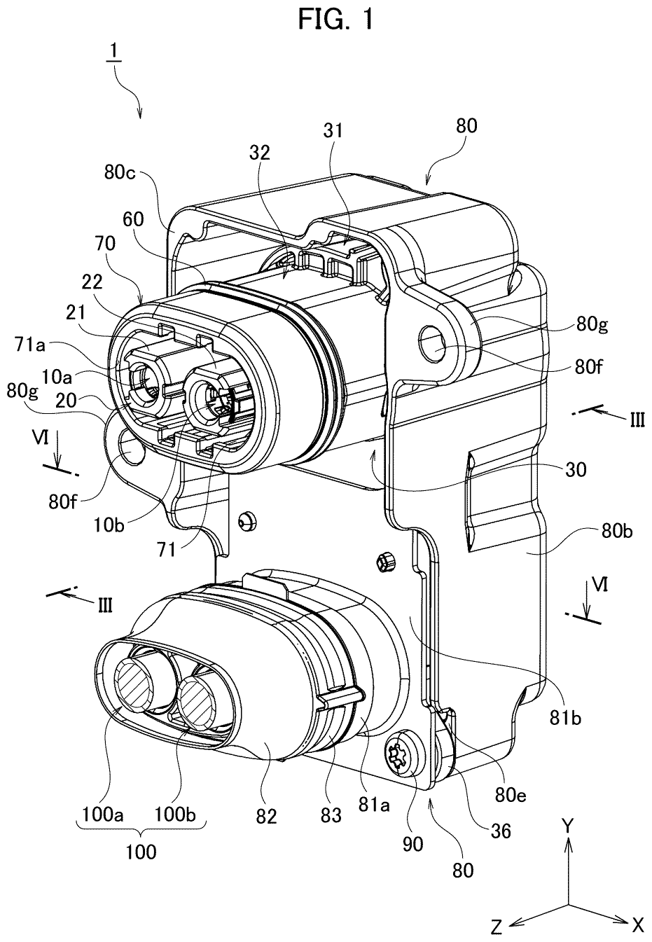

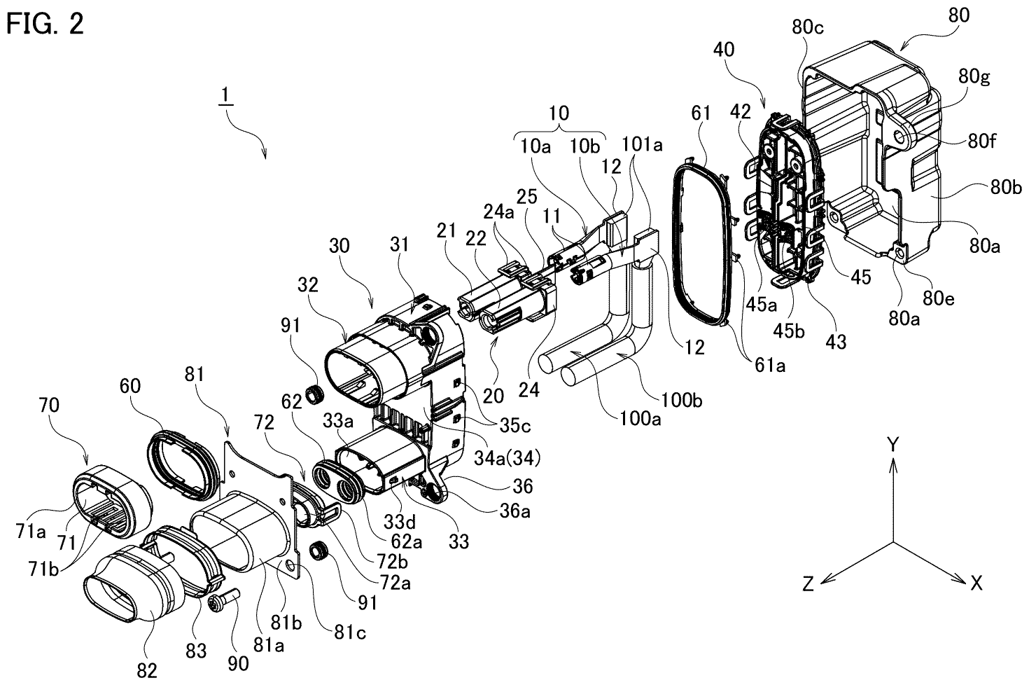

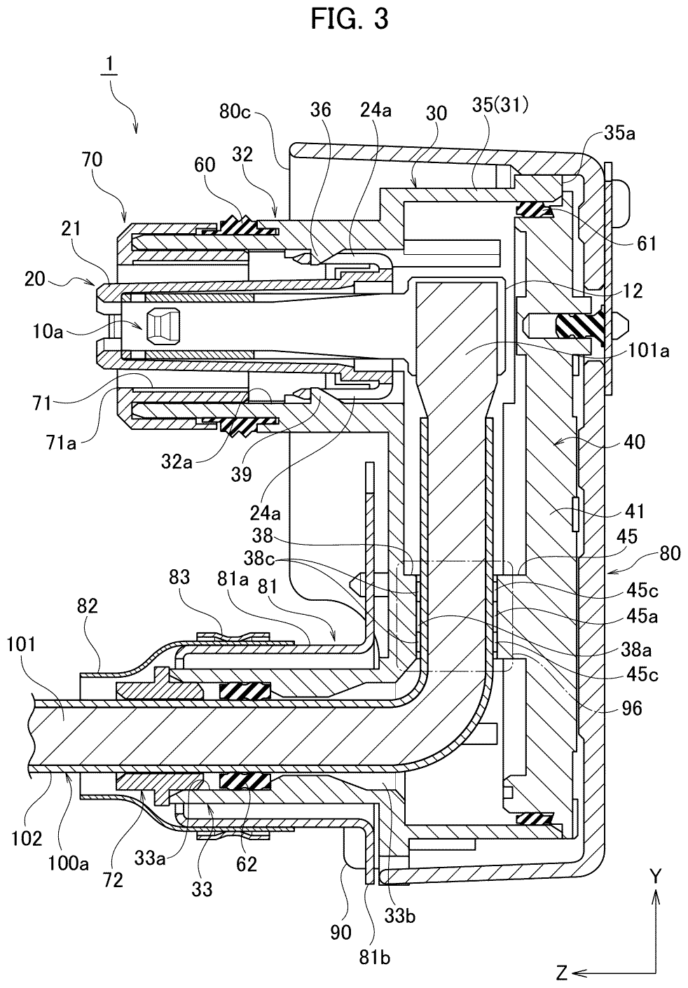

FIG. 1 is a perspective view of a connector 1 according to an embodiment. FIG. 2 is an exploded perspective view of the connector 1. FIG. 3 is a cross-sectional view of the connector 1 cut at section III-III in FIG. 1. The cross section in FIG. 3 is an imaginary plane that passes through a center axis of a first terminal receptacle 21 and the first electric wire 100a of an inner housing 20 described later. The imaginary plane is the YZ plane in this embodiment.

The connector 1 is, for example, a high-voltage connector that can be employed in a drive-system electrical component such as an inverter, a DC/DC converter, or a charger mounted on an electric vehicle or a hybrid vehicle. In this embodiment, the connector 1 is a two-pole high-voltage connector mounted on a vehicle that is connected to ends of the two electric wires 100, a first electric wire 100a and a second electric wire 100b. The electric wires 100 have a core wire 101 as a conductor, and a coating portion 102 as an insulator for coating the core wire 101. The electric wires 100 are connected to an electrical component on one end, and the electric wires 100 are connected to the connector 1 on the other end. The coating portion 102 of the electric wires 100 is removed at one end which is connected to the connector 1, so that an end 101a of the core wire 101 is exposed. The core wire 101 may actually be composed of a plurality of wires, but in the following drawings, it is simply illustrated as a single conductor member.

The connector 1 includes a plurality of terminals 10, an inner housing 20, an outer housing 30, and a rear cover 40 as a group of components related to electrical connection.

In this embodiment, there are two terminals 10: a first terminal 10a attached to an end of the first electric wire 100a, and a second terminal 10b attached to an end of the second electric wire 100b. The first terminal 10a and the second terminal 10b are female terminals made of metal and having the same shape, and each have a connecting portion 11 and a joint 12.

The connecting portion 11 is a cylindrical portion into which a rod-shaped male terminal can be freely inserted as an external terminal of an external connector to be connected to the connector 1. The connecting portion 11 has a leaf spring that presses a part of the male terminal against an inner wall of the connecting portion 11 in order to stably maintain a conductive state with the male terminal inserted therein. The leaf spring may be a portion integrated with the connecting portion 11, or a leaf spring member prepared separately and arranged in advance inside the connecting portion 11.

The joint 12 is formed as a flat plate for joining the end 101a of the core wire 101. If one axial end of the connecting portion 11 is an opening end into which the male terminal is inserted, the joint 12 is integrated with the other axial end of the connecting portion 11. Hereinafter, in this embodiment, it is assumed that an axial direction of the connecting portion 11 is in a Z direction when the terminals 10 are arranged in the connector 1. In this case, the joint 12 may be a flat plate parallel to both the Z direction and a Y direction. For example, a planar shape of the joint 12 may be substantially rectangular, with two edges aligned in the Z direction and two other edges aligned in the Y direction that is perpendicular to the Z direction. One surface of the joint 12 is a joining surface to which the end 101a is joined.

In the present embodiment, the end 101a of the core wire 101 is joined to the joint 12 by ultrasonic joining. In ultrasonic joining, the joint 12 is clamped together with the end 101a by a horn and an anvil (not illustrated), and the end 101a is joined to the joint 12 by applying ultrasonic vibration from the horn. Therefore, as illustrated in FIG. 2, the end 101a joined to the joint 12 is formed as a flat plate having a substantially rectangular planar shape.

During ultrasonic joining, a direction from the joint 12 to the connecting portion 11 in the axial direction of the connecting portion 11, and a direction from the end 101a on the joint 12 to the main body of each of the electric wires 100, are displaced by 90° for the terminals 10. That is, when the terminals 10 are arranged in the connector 1, the end 101a is oriented in the Y direction with respect to one surface of the joint 12 when the axial direction of the connecting portion 11 is aligned in the Z direction. Then, each of the electric wires 100 extends from the end 101a in a direction opposite to the Y direction with the end 101a on the joint 12 as a starting point.

The inner housing 20 is an insulating member made of a synthetic resin, for example, for holding both of the terminals 10 therein to protect the terminals 10. The inner housing 20 includes the first terminal receptacle 21, a second terminal receptacle 22, a base 24, and a reinforcing structure 25.

The first terminal receptacle 21 is a cylindrical portion that receives the connecting portion 11 of the first terminal 10a. The second terminal receptacle 22 is a cylindrical portion that receives the connecting portion 11 of the second terminal 10b. The first terminal receptacle 21 and the second terminal receptacle 22 receive the connecting portion 11 so that an opening direction of the connecting portion 11 received therein, that is, a direction opposite to a direction in which the male terminal is inserted, is a direction aligned in the first direction. In this embodiment, the first direction is the Z direction. A tip of the first terminal receptacle 21 and a tip of second terminal receptacle 22 are open in the first direction, and do not prevent a male terminal from entering the connecting portion 11. The first terminal receptacle 21 and the second terminal receptacle 22 are arranged in the same stage in the Y direction as the second direction defined below, and are spaced from each other in the X direction as the third direction defined below.

The base 24 supports the first terminal receptacle 21 and the second terminal receptacle 22. The base 24 supports root ends of the first terminal receptacle 21 and the second terminal receptacle 22 on a front side in the first direction. An internal space of the first terminal receptacle 21 and an internal space of the second terminal receptacle 22 are open in a direction opposite to the first direction on a rear surface side in the first direction.

The base 24 includes a total of four locks 24a. For example, two locks 24a are arranged opposite two other locks 24a in the second direction. On the other hand, a total of four first engaging claws 37 are arranged inside the housing body 31 of the outer housing 30. Two first engaging claws 37 are arranged opposite two other first engaging claws 37 in the second direction. When the inner housing 20 is attached to the outer housing 30, the locks 24a are engaged with the first engaging claws 37, thereby preventing the inner housing 20 from coming off the outer housing 30.

The reinforcing structure 25 is a structure in which a plurality of reinforcing ribs are combined to ensure the strength of the inner housing 20. The reinforcing structure 25 is provided on a rear surface of the base 24 so as not to interfere with the arrangement of the terminals 10 and the electric wires 100.

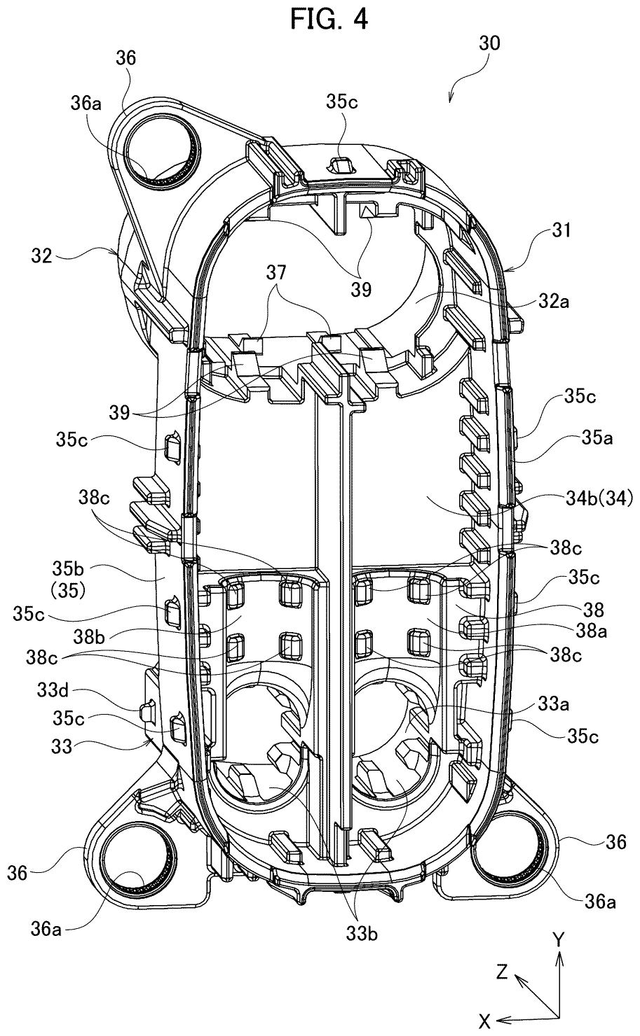

FIG. 4 is a perspective view of the outer housing 30 in a direction in which an internal space can be visually recognized from an opening formed by an opening end 35a.

The outer housing 30 is made of a synthetic resin, for example, and is an insulating member that entirely protects both of the terminals 10 by receiving at least a part of the inner housing 20 and the joint 12 of each of the terminals 10. The outer housing 30 has the housing body 31, a connector shell 32, and an electric wire lead-out portion 33.

The housing body 31 is a box in which, when a first direction is a length direction, a second direction perpendicular to the first direction is a height direction, and a third direction perpendicular to both the first direction and the second direction is a width direction. In this embodiment, the first direction is the Z direction, the second direction is the Y direction, and the third direction is the X direction as described above. The housing body 31 has a front wall 34, an annular side wall 35, and a plurality of support pieces 36.

The front wall 34 is a wall perpendicular to the first direction, and is supported by a first wall surface 34a (see FIG. 2) so that the connector shell 32 and the electric wire lead-out portion 33 are separated from each other in the second direction. The planar shape of the front wall 34 is substantially a rectangle defined by a long side substantially aligned in the second direction and a short side substantially aligned in the third direction.

The front wall 34 has a first electric wire contact 38 on a second wall surface 34b facing the interior of the housing body 31. When the rear cover 40 is attached to the outer housing 30, the first electric wire contact 38 faces, and is arranged spaced apart from, a second electric wire contact 45 provided on the rear cover 40. The first electric wire contact 38 is combined with the second electric wire contact 45 to form an electric wire clamping unit 96. The first electric wire contact 38 has a first curved surface groove 38a and a second curved surface groove 38b, each extending in a second direction and including a curved surface matching a shape of a side surface of the electric wires 100 routed inside the housing body 31. The first curved surface groove 38a receives a part of the side surface of the first electric wire 100a. The second curved surface groove 38b receives a part of the side surface of the second electric wire 100b.

Each of the first curved surface groove 38a and the second curved surface groove 38b has a plurality of first ribs 38c. The first ribs 38c are convex portions protruding in a normal direction from a curved surface forming the first curved surface groove 38a or the second curved surface groove 38b. In the present embodiment, both the first curved surface groove 38a and the second curved surface groove 38b have, as an example, a total of four first ribs 38c arranged in two rows in the second direction. In this case, two first ribs 38c are aligned in a circumferential direction of the curved surface, and two first ribs 38c are aligned in the second direction. In the present embodiment, two first ribs 38c are arranged on each curved surface of the first curved surface groove 38a and the second curved surface groove 38b so as to be symmetrical with respect to a virtual central axis defining the shape of each curved surface viewed in the Z-direction.

The annular side wall 35, together with the front wall 34, forms an internal space for receiving at least the joint 12 of the terminals 10. One annular end of the annular side wall 35 in the first direction is continuous with a peripheral edge of the front wall 34. The other annular end of the annular side wall 35 in the first direction is an opening end 35a that forms an opening opposed to the front wall 34. When the connector 1 is assembled, the two terminals 10, each attached to ends of the electric wires 100, are received in the housing body 31 from the opening formed by the opening end 35a. Further, the annular side wall 35 has a plurality of engaging portions 35c provided on an outer wall surface 35b and spaced apart from each other in the circumferential direction.

The support pieces 36 are provided on the outer wall surface 35b of the annular side wall 35, and include fitting holes 36a into which annular collars 91 are fitted. The fitting holes 36a penetrate the support pieces 36 in the first direction.

The connector shell 32 has a shell opening 32a having a shape of an elongated round hole in cross section, and opening in the first direction. The connector shell 32 is a cylindrical portion which is fitted with a part of the external connector when the external connector having a male terminal is connected to the connector 1. The connector shell 32 is provided so as to protrude in the first direction from the front wall 34 of the housing body 31. The shell opening 32a penetrates the inside of the housing body 31 from the outside of the outer housing 30, and can receive the inner housing 20. In the cross section of the elongated round hole of the shell opening 32a, the second direction is a longitudinal direction in accordance with the arrangement relationship between the first terminal receptacle 21 and the second terminal receptacle 22 in the inner housing 20.

An outer periphery of the connector shell 32 includes a lower surface which is located on a tip side in the first direction, and to which a unit packing 60 is attached, and an upper surface located on a base side in the first direction. A shape of an outer periphery of the upper surface is larger than a shape of an outer periphery of the lower surface. Therefore, at least a part of the unit packing 60 faces an end of the upper surface in the first direction when the unit packing 60 is attached to the lower surface. Therefore, movement of the unit packing 60 to the base side of the connector shell 32 by a certain amount or more is restricted.

Further, the connector shell 32 has a plurality of first engaging claws 37 across the shell opening 32a. In this embodiment, there are four first engaging claws 37 as described above. Similarly, the connector shell 32 has a plurality of second engaging claws 39 across the shell opening 32a. In this embodiment, there are four second engaging claws 39. The four second engaging claws 39 are arranged in pairs so as to face each other in the second direction.

The electric wire lead-out portion 33 is a cylindrical portion for leading the electric wires 100 out from the inside of the housing body 31 to the outside of the outer housing 30, through a through-space formed by the inner wall surface 33a, and having an elongated round hole shape in cross section opening in the first direction. The electric wire lead-out portion 33 is provided to protrude in the first direction from the front wall 34 of the housing body 31. In an elongated round cross section of the through-space, the second direction is the longitudinal direction, so that the electric wires 100 are aligned in the second direction in accordance with the arrangement relationship of the first terminal receptacle 21 and the second terminal receptacle 22 in the inner housing 20. The electric wire lead-out portion 33 has a plurality of routing holes 33b, and a plurality of holder engaging portions 33d.

The routing holes 33b extend in the first direction, and enable the electric wires 100 to lead out from the inside of the housing body 31 to be routed in the first direction. The through-holes of the routing holes 33b have a circular or elliptical shape in cross section. In the present embodiment, two routing holes 33b are provided in parallel in the third direction, since two electric wires 100 are led out from the inside of the housing body 31.

In the present embodiment, the holder engaging portions 33d are provided at both ends of the electric wire lead-out portion 33 in the third direction corresponding to the X direction. The holder engaging portions 33d engage with engaging portions 72b provided in a rear holder 72.

In other words, in the structure of the outer housing 30, in the connector 1, a direction in which the shell opening 32a of the connector shell 32 is oriented, that is, the direction in which the connector is connected to the external connector, and the direction in which the electric wires 100 are led out from the electric wire lead-out portion 33, are both aligned in the same direction. In this embodiment, the direction in which the shell opening 32a of the connector shell 32 is directed, and the direction in which the electric wires 100 are led out from the electric wire lead-out portion 33, are both aligned in the first direction corresponding to the Z direction.

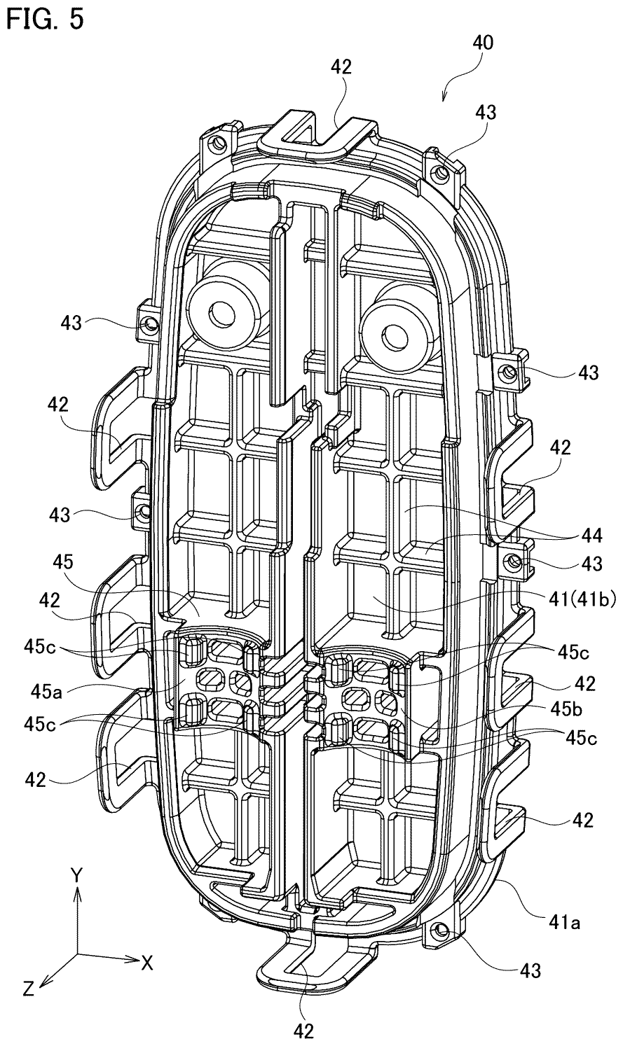

FIG. 5 is a perspective view of the rear cover 40 in a direction in which a side to be attached to the outer housing 30 can be visually recognized.

The rear cover 40 is made of, for example, a synthetic resin, and is an insulating member for covering an opening formed by the opening end 35a after the terminals 10 with the end 101a joined to the joint 12 are received together with ends of the electric wires 100 in the housing body 31 of the outer housing 30. The rear cover 40 has a body wall 41, a plurality of locking portions 42, a plurality of packing-locking portions 43, reinforcing ribs 44, and a second electric wire contact 45.

The body wall 41 is a flatplate having an outer peripheral edge 41a along the opening end 35a of the housing body 31 when the rear cover 40 is attached to the outer housing 30. An inner wall surface 41b of the body wall 41 faces the front wall 34 of the housing body 31 when the rear cover 40 is attached to the outer housing 30.

The locking portions 42 are provided on the outer peripheral edge 41a of the body wall 41, spaced at intervals from each other in a circumferential direction along the outer peripheral edge 41a. When the rear cover 40 is attached to the outer housing 30, the locking portions 42 prevent the rear cover 40 from coming off the outer housing 30 by engaging the engaging portions 35c on the annular side wall 35.

The packing-locking portions 43 are provided on the outer peripheral edge 41a of the body wall 41 at intervals from each other in the circumferential direction along the outer peripheral edge 41a, avoiding the plurality of locking portions 42. A rear cover packing 61 described later is provided with a plurality of engaging projections 61a. Each of the packing-locking portions 43 engages one of the engaging projections 61a on the rear cover packing 61 when the rear cover 40 is attached to the outer housing 30.

In order to ensure the strength of the rear cover 40, the reinforcing ribs 44 are provided on the inner wall surface 41b so as not to interfere with the arrangement of the terminals 10 and the electric wires 100.

The second electric wire contact 45 is provided on the inner wall surface 41b, and is combined with the first electric wire contact 38 to form the electric wire clamping unit 96, as described above. The second electric wire contact 45 contacts the electric wires 100 when the rear cover 40 is attached to the outer housing 30. The second electric wire contact 45 has a first curved surface groove 45a and a second curved surface groove 45b, each extending in the second direction and including a curved surface matching a shape of the side surface of the electric wires 100 routed inside the housing body 31. The first curved surface groove 45a receives a part of the side surface of the first electric wire 100a. The second curved surface groove 45b receives a part of the side surface of the second electric wire 100b.

Each of the first curved surface groove 45a and the second curved surface groove 45b has a plurality of first ribs 45c. The first ribs 45c are convex portions protruding in the normal direction from a curved surface forming the first curved surface groove 45a or the second curved surface groove 45b. In the present embodiment, both of the first curved surface groove 45a and the second curved surface groove 45b have, as an example, a total of four first ribs 45c arranged in two rows in the second direction. In this case, two first ribs 45c are aligned in a circumferential direction of the curved surface, and two first ribs 45c are aligned in the second direction. In the present embodiment, two first ribs 38c are arranged on each curved surface of the first curved surface groove 38a and the second curved surface groove 38b, so as to be symmetrical with respect to a virtual central axis defining the shape of each curved surface viewed in the Z-direction. Further, in the present embodiment, when the rear cover 40 is attached to the outer housing 30, and the first electric wire contact 38 and the second electric wire contact 45 are opposed to each other, the four first ribs 38c and the four second ribs 45c are substantially opposed to each other in the Z-direction.

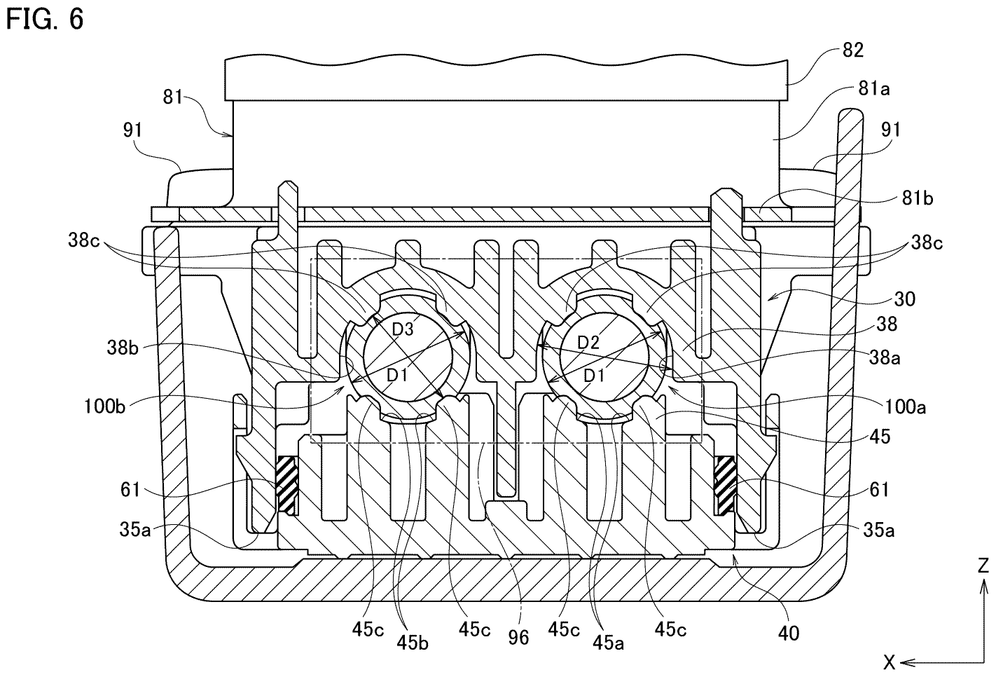

FIG. 6 is a cross-sectional view of the connector 1 cut at a section VI-VI in FIG. 1. The cut surface in FIG. 6 is a virtual surface passing through a part of the two first ribs 38c located on an upper stage in the second direction among the four first ribs 38c, and a part of the two second ribs 45c located on an upper stage in the second direction among the four second ribs 45c. The virtual surface is an XZ plane in the present embodiment.

When the rear cover 40 is attached to the outer housing 30, the first electric wire contact 38 and the second electric wire contact 45 clamp the electric wires 100. Specifically, a part of the first electric wire 100a is held between the first curved surface groove 38a provided as a part of the outer housing 30, and the first curved surface groove 45a provided as a part of the rear cover 40. Then, the four first ribs 38c of the first curved surface groove 38a and the four second ribs 45c of the first curved surface groove 45a are press-fitted into the coating portion 102 on the outer periphery of the first electric wire 100a. Similarly, a part of the second electric wire 100b is clamped between the second curved surface groove 38b as a part of the outer housing 30 and the second curved surface groove 45b as a part of the rear cover 40. Then, the four first ribs 38c of the second curved surface groove 38b, and the four second ribs 45c of the second curved surface groove 45b, are press-fitted into the coating portion 102 on the outer periphery of the second electric wire 100b.

Specifically, when the rear cover 40 is attached to the outer housing 30, both curved surfaces of the first curved surface groove 38a and the first curved surface groove 45a are not in contact with the first electric wire 100a, and neither curved surface of the second curved surface groove 38b and the second curved surface groove 45b is in contact with the second electric wire 100b. For example, when the first curved surface groove 38a and the first curved surface groove 45a clamp the first electric wire 100a, it is assumed that the cross sections of both curved surfaces of the first curved surface groove 38a, and the first curved surface groove 45a, are on one virtual circle with a diameter D2. Similarly, when the second curved surface groove 38b and the second curved surface groove 45b clamp the second electric wire 100b, it is assumed that the cross sections of both curved surfaces of the second curved surface groove 38b, and the second curved surface groove 45b, are on one virtual circle with the diameter D2. In this case, the diameter D2 is larger than an outer diameter D1 of the electric wires 100.

Further, when the rear cover 40 is attached to the outer housing 30, portions press-fitted into the coating portion 102 of the electric wires 100 are tip portions of the first ribs 38c or the second ribs 45c. For example, when the first curved surface groove 38a and the first curved surface groove 45a clamp the first electric wire 100a, it is assumed that tip surfaces of the first ribs 38c on the first curved surface groove 38a, and tip surfaces of the second ribs 45c on the first curved surface groove 45a, are on one virtual circle with a diameter D3. Similarly, when the second curved surface groove 38b and the second curved surface groove 45b clamp the second electric wire 100b, it is assumed that tip surfaces of the first ribs 38c on the second curved surface groove 38b, and tip surfaces of the second ribs 45c on the second curved surface groove 45b, are on one virtual circle with the diameter D3. In this case, the diameter D3 is smaller than the outer diameter D1 of the electric wires 100.

It should be noted that the outer diameter D1 of the electric wires 100, and the diameters D2 and D3 of the two virtual circles, are expressed as diameter dimensions around a specific center axis in the second direction corresponding to the Y direction.

Further, the connector 1 includes the unit packing 60, the rear cover packing 61, and a wire packing 62 as waterproof members for preventing moisture from entering the outer housing 30 from the outside.

The unit packing 60 is an annular elastic member closely attached to the outer peripheral surface of the connector shell 32 in the outer housing 30. The unit packing 60 seals a space between the outer peripheral surface of the connector shell 32 and the fitting surface of an external connector when the external connector is connected to the connector 1.

The rear cover packing 61 is an annular elastic member closely attached to the opening end 35a of the housing body 31 of the outer housing 30. When the rear cover 40 is attached to the outer housing 30, the rear cover packing 61 seals a space between the opening end 35a of the housing body 31 and the outer peripheral edge 41a of the rear cover 40.

The wire packing 62 is an elastic member in the shape of an elongated round flat plate that is closely attached to the inner wall surface 33a of the electric wire lead-out portion 33 of the outer housing 30. In addition, the wire packing 62 has two through-holes 62a through which the electric wires 100 individually pass in close contact with the through-holes 62a. The wire packing 62 seals a space between the inner wall surface 33a of the electric wire lead-out portion 33 and the electric wires 100 that pass through a through-space of the electric wire lead-out portion 33.

Further, the connector 1 includes a front holder 70 and the rear holder 72 as holding members for different kinds of packing.

The front holder 70 is made of a synthetic resin, and is a cylindrical member attached to the connector shell 32 in order to prevent the unit packing 60 from coming off the connector shell 32 of the outer housing 30. The front holder 70 is formed to engage with a tip of the connector shell 32 while being partially received in the shell opening 32a of the connector shell 32. When the front holder 70 is attached to the connector shell 32, it faces at least a part of the unit packing 60 in the first direction. Therefore, even if the unit packing 60 moves to the tip of the connector shell 32, further movement is restricted by abutment on a part of the front holder 70, thus preventing it from coming off the connector shell 32.

The first terminal receptacle 21 and the second terminal receptacle 22 of the inner housing 20 penetrate inside the inner wall 71 of the front holder 70. An opening 71a communicating with the inner wall 71 exposes tips of the first terminal receptacle 21 and the second terminal receptacle 22 to the outside.

Further, the front holder 70 has a plurality of engaging portions 71b on a part of the inner wall 71. The engaging portions 71b are engaged with the first engaging claws 37 provided on the connector shell 32. That is, in the present embodiment, four engaging portions 71b are provided corresponding to the number of the first engaging claws 37 provided. When the front holder 70 is attached to the connector shell 32, the engaging portions 71b are engaged with the first engaging claws 37 to prevent the front holder 70 from coming off the connector shell 32.

The rear holder 72 is made of a synthetic resin, and is attached to the electric wire lead-out portion 33 to prevent the wire packing 62 from coming off the electric wire lead-out portion 33 of the outer housing 30. The rear holder 72 has two through-holes 72a for each enabling the electric wires 100 to penetrate, and is an elongated flat plate member similar in shape to the wire packing 62. The rear holder 72 is inserted into the through-space from a tip of the electric wire lead-out portion 33, and supported by the electric wire lead-out portion 33 with the wire packing 62 that seals the space between the inner wall surface 33a of the electric wire lead-out portion 33, and the electric wires 100. Thus, the rear holder 72 prevents the wire packing 62 from coming off the electric wire lead-out portion 33.

Further, the rear holder 72 has a plurality of locking portions 72b protruding from an outer peripheral edge in a direction opposite to the first direction. The locking portions 72b are engaged with the holder engaging portions 33d provided in the electric wire lead-out portion 33. That is, in this embodiment, two locking portions 72b are provided corresponding to the number of holder engaging portions 33d provided. When the rear holder 72 is attached to the electric wire lead-out portion 33, the locking portions 72b are engaged with the holder engaging portions 33d, thereby preventing the rear holder 72 from coming off the electric wire lead-out portion 33.

Further, the connector 1 includes an upper shell 80, a lower shell 81, a shield braid 82, and a shield ring 83 as shielding members for shielding noise.

The upper shell 80 is made of metal and covers the housing body 31 of the outer housing 30 with the rear cover 40 attached thereto. The upper shell 80 may cover at least a part of the connector shell 32 or the electric wire lead-out portion 33 of the outer housing 30 while receiving the housing body 31. The upper shell 80 is a box portion defined as having a first direction corresponding to the Z direction as a length direction, a second direction corresponding to the Y direction as a height direction, and a third direction corresponding to the X direction as a width direction. The upper shell 80 has a bottom wall 80a, an annular side wall 80b, a plurality of support portions 80e, and a plurality of support pieces 80g.

The bottom wall 80a is a wall portion orthogonal to the first direction. The planar shape of the bottom wall 80a is a substantially rectangular defined by a long side substantially aligned in the second direction, and a short side substantially aligned in the third direction.

The annular side wall 80b, together with the bottom wall 80a, forms an internal space for receiving the housing body 31. One annular end of the annular side wall 80b in the first direction is continuous with a peripheral part of the bottom wall 80a. The other annular end of the annular side wall 80b in the first direction is an opening end 80c forming an opening facing the bottom wall 80a. When the connector 1 is assembled, the housing body 31 to which the rear cover 40 is attached is accommodated from the opening formed by the opening end 80c.

The support portions 80e have first through-holes 80d through which bolts 90 after passing through the fitting holes 36a provided in the outer housing 30 pass when the connector 1 is assembled.

The support pieces 80g are portions, for example, provided by bending a part protruding from the opening end 80c of the annular side wall 80b, and each have a second through hole 80f through which a mounting bolt (not illustrated) passes when the connector 1 is attached to a housing of an external connector.

The lower shell 81 is made of metal, and covers a part of the front wall 34 of the housing body 31 of the outer housing 30, and the electric wire lead-out portion 33. The lower shell 81 has a cylindrical portion 81a and a flange 81b.

The cylindrical portion 81a covers the electric wire lead-out portion 33 by receiving the electric wire lead-out portion 33 through a through-space having an elongated round hole in cross section and opening in the first direction. One opening end of the cylindrical portion 81a is a fixing end continuous with the flange 81b. The other opening end of the cylindrical portion 81a is an opening end forming an opening for leading out the electric wires 100 from the electric wire lead-out portion 33.

The flange 81b, which is a flat plate orthogonal to the first direction, faces a part of the front wall 34 to cover a part of the front wall 34. Further, the flange 81b has through-holes 81c through which the bolts 90 pass before passing through the fitting holes 36a provided in the outer housing 30 when the connector 1 is assembled.

The shield braid 82 is a metallic braid, a part of which covers a tip of the cylindrical portion 81a, and another part of which wraps to integrally cover both of the electric wires 100 led out from the cylindrical portion 81a.

The shield ring 83 is a metallic fastening member for press fitting of the shield braid 82 to an outer peripheral surface of the cylindrical portion 81a of the lower shell 81.

Further, the connector 1 includes a plurality of the bolts 90 and a plurality of the annular collars 91 previously fitted into the fitting holes 36a of the outer housing 30 as members for assembling components. As described above, the flange 81b of the lower shell 81 is provided with through-holes 81c. The annular collars 91 are fitted into the fitting holes 36a of the outer housing 30. The support portions 80e of the upper shell 80 are provided with the first through-holes 80d. The bolts 90 are fastened through the through-holes 81c, the annular collars 91 of the fitting holes 36a, and the first through-holes 80d, and whereby the lower shell 81, the outer housing 30, and the upper shell 80 are integrally assembled.

Next, the operation and effect of the connector 1 will be described.

The connector 1 connected to an external connector includes a plurality of the terminals 10, and the electric wire lead-out portion 33 for leading out the plurality of electric wires 100 partially joined to the terminals 10, in a first direction in which the connector 1 is connected to the external connector. Further, the connector 1 includes a combination of a first electric wire contact 38 and a second electric wire contact 45 for partially clamping the electric wires 100 extending in a second direction, intersecting with the first direction, between the terminals 10 and the electric wire lead-out portion 33. The first electric wire contact 38 is integrated with a member having the electric wire lead-out portion 33.

In the illustrated example, the electric wires 100 correspond to the first electric wire 100a and the second electric wire 100b. In the illustrated example, the terminals 10 correspond to the first terminal 10a attached to an end of the first electric wire 100a, and the second terminal 10b attached to an end of the second electric wire 100b. In the illustrated example, the first direction corresponds to the Z direction, and the second direction corresponds to the Y direction. The first direction and the second direction are orthogonal in the above description, but not limited to an orthogonal case. In the above example, the combination of the first electric wire contact 38 and the second electric wire contact 45 is illustrated as an electric wire clamping unit 96.

In the connector 1, the electric wires 100 are partially clamped by a combination of the first electric wire contact 38 and the second electric wire contact 45 between the terminals 10 and the electric wire lead-out portion 33. Therefore, for example, a reaction force generated by oscillation of the electric wires 100 due to vibration of a vehicle is prevented from being transmitted to the terminals 10 through the electric wires 100 led out from the electric wire lead-out portion 33. Therefore, a portion in which the joint 12, as a part of the terminals 10, is joined to the end 101a of the core wire 101 of the electric wires 100 is protected, so that the reliability of a joint can be improved.

Here, as in the illustrated example above, when the end 101a is joined to the joint 12 of each of the terminals 10 by ultrasonic bonding, the end 101a is easily separated from a joint surface of the joint 12 by oscillation of the electric wires 100 directly applied to the joint 12. On the other hand, with the connector 1 according to the present embodiment, the oscillation of each of the electric wires 100 is not easily transmitted to the end 101a joined to the joint 12 by ultrasonic bonding, so that the end 101a can be prevented from being separated in a simple manner.

Further, the connector 1 has a general U-shape in which a direction of connection to the external connector and a direction of leading out the electric wires 100 to the outside are aligned in the first direction. In this case, the electric wires 100 which extend from the terminals 10 in the second direction are once bent inside the connector 1, since they are eventually lead out from the electric wire lead-out portion 33 in the first direction. As a result, a reaction force can also be generated by bending the electric wires 100. However, the electric wires 100 extending from the terminals 10 in the second direction toward the bent portion are partially clamped by the combination of the first electric wire contact 38 and the second electric wire contact 45. Therefore, the reaction force caused by the bending of the electric wires 100 is prevented from being transmitted to the terminals 10, and the reliability of a joint can be improved in the same manner as described above.

Further, as a comparative example, in order to prevent the reaction force through the electric wires 100 from being transmitted to the terminals 10, it is possible to provide a crimping portion as a portion separate from the joint 12 for connecting a portion closer to the bent portion than the end 101a of each of the electric wires 100 to each of the terminals 10. However, when the terminals 10 have such a crimping portion, the terminals 10 may be enlarged, or the yield may be reduced, resulting in an increase in cost. On the other hand, in the connector 1 according to the present embodiment, the first electric wire contact 38 is integrated with a member having the electric wire lead-out portion 33, so that a structure for clamping the electric wires 100 can be easily realized. In other words, with the connector 1, it is possible to prevent a reduction in yield while suppressing enlargement of the components.

As described above, according to the present embodiment, it is possible to provide the connector 1 having a simple structure for improving the reliability of the connection between the terminals 10 and the electric wires 100.

Further, the connector 1 may include an outer housing 30 having at least the housing body 31 for receiving the end 101a of the electric wires 100 and the electric wire lead-out portion 33. The connector 1 may also include a rear cover 40 for covering an opening formed by the opening end 35a of the housing body 31 after the end 101a of the electric wires 100 is received in the housing body 31. The first electric wire contact 38 may be provided on the housing body 31. The second electric wire contact 45 may be provided on the rear cover 40.

The housing body 31 and the rear cover 40 have portions facing each other across a part of the electric wires 100 in terms of the structure in which the rear cover 40 covers the opening of the housing body 31 after the end 101a is received in the housing body 31. Therefore, in the connector 1, the first electric wire contact 38 can be provided by simply changing the shape of the housing body 31, as compared with a hypothetical case in which the housing body 31 does not have the first electric wire contact 38. Similarly, as compared with the hypothetical case in which the rear cover 40 does not have the second electric wire contact 45, the second electric wire contact 45 can be provided by simply changing the shape of the rear cover 40.

Further, in the connector 1, at least one of the first electric wire contact 38 and the second electric wire contact 45 may have a curved surface groove formed with a curved surface matching a side surface shape of the electric wires 100 for each of the electric wires 100.

In the illustrated example, the first electric wire contact 38 has a first curved surface groove 38a facing the first electric wire 100a, and a second curved surface groove 38b facing the second electric wire 100b. In the illustrated example, the second electric wire contact 45 has a first curved surface groove 45a facing the first electric wire 100a, and a second curved surface groove 45b facing the second electric wire 100b.

In the connector 1, when the first electric wire contact 38 and the second electric wire contact 45 partially clamp the electric wires 100, curved surface grooves are arranged to surround at least a part of side surfaces of the electric wires 100 in the circumferential direction. Therefore, the first electric wire contact 38, or the second electric wire contact 45, each having a curved surface groove, can more stably contact the electric wires 100.

It should be noted that in the above description, the configuration in which both the first electric wire contact 38 and the second electric wire contact 45 have a curved surface groove is exemplified, but it is also possible to have a configuration in which only one of the first electric wire contact 38 and the second electric wire contact 45 has a curved surface groove. For example, when the first electric wire contact 38 has a curved surface groove, the configuration in which the second electric wire contact 45 contacts the electric wires 100 in a simple plane can be made to further simplify the shape of the rear cover 40 without a curved surface groove.

Further, in the connector 1, the curved surface groove may have ribs partially press-fitted into the coating portion 102 on an outer periphery of the electric wires 100 when the first electric wire contact 38 and the second electric wire contact 45 clamp the electric wires 100.

In the illustrated example, each of the first curved surface groove 38a and the second curved surface groove 38b of the first electric wire contact 38 has four first ribs 38c. Similarly, in the illustrated example, each of the first curved surface groove 45a and the second curved surface groove 45b of the second electric wire contact 45 has four second ribs 45c.

In the connector 1, when the first electric wire contact 38 and the second electric wire contact 45 clamps the electric wires 100, the ribs are press-fitted to partially squash the coating portion 102 of the electric wires 100. Therefore, the first electric wire contact 38 and the second electric wire contact 45 can more firmly support the electric wires 100, and it is thus possible to more reliably prevent the reaction force generated by the oscillation of the electric wires 100 from being transmitted to the terminals 10 through the electric wires 100.

In the connector 1, a plurality of ribs may be provided for each curved surface groove in a circumferential direction of the curved surface of the curved surface groove.

In the above example, as illustrated in FIG. 6, two ribs, such as the first ribs 38c, are arranged for each curved surface groove such as the first curved surface groove 38a in a circumferential direction of a curved surface.

With the connector 1, a plurality of ribs are arranged for each curved surface groove in a circumferential direction of a curved surface of a curved surface groove, and rotational displacement around an axis of the electric wires 100 can be easily prevented. Therefore, it is possible to more reliably prevent the reaction force generated by oscillation of the electric wires 100 from being transmitted to the terminals 10 through the electric wires 100.

In the connector 1, a plurality of ribs may be provided for each curved surface groove in the second direction.

In the illustrated example, as in FIG. 3, the ribs, such as the first ribs 38c, are arranged in two stages in the second direction corresponding to the Y direction for each curved surface groove, such as the first curved surface groove 38a.

With the connector 1, a plurality of ribs are arranged in the second direction for each curved surface groove, displacement of the electric wires 100 in an extending direction can be easily prevented. Therefore, it is possible to more reliably prevent reaction force generated by oscillation of the electric wires 100 from being transmitted to the terminals 10 through the electric wires 100.

In the connector 1, a curved surface groove may contact each of the electric wires 100 entirely with the curved surface.

In this case, each curved surface groove, such as the first curved surface groove 38a, does not have ribs, such as the first ribs 38c. The curved surface itself, on which the ribs are provided in the above description, clamps each of the electric wires 100. That is, if a diameter of a cross section of a curved surface forming a curved surface groove, as illustrated in FIG. 6, is denoted as the diameter D2, the diameter D2 in this case is smaller than the outer diameter D1 of the electric wires 100.

With the connector 1, when the electric wires 100 are clamped between the first electric wire contact 38 and the second electric wire contact 45, the curved surface of the curved surface groove entirely contacts the coating portion 102 of the electric wires 100 to squash the entire circumference thereof. Therefore, the first electric wire contact 38 and the second electric wire contact 45 are capable of entirely supporting a part of the length of the electric wires 100, so that it is possible to more reliably prevent the reaction force generated by oscillation of the electric wires 100 from being transmitted to the terminals 10 through the electric wires 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector connected to an external connector, comprising:
a plurality of terminals;
an electric wire lead-out portion for leading out a plurality of electric wires, partially joined to the terminals, in a first direction to be connected to the external connector; and
a combination of a first electric wire contact and a second electric wire contact for partially clamping the electric wires extending in a second direction, intersecting with the first direction, between the terminals and the electric wire lead-out portion;
wherein the first electric wire contact is integrated with a member having the electric wire lead-out portion.

2. The connector according to claim 1, further comprising:
an outer housing having a housing body for receiving at least an end of the electric wires and the electric wire lead-out portion; and
a rear cover for covering an opening formed by an opening end of the housing body after the end of the electric wires is received in the housing body;
wherein
the first electric wire contact is provided on the housing body; and
the second electric wire contact is provided on the rear cover.

3. The connector according to claim 1, wherein at least one of the first electric wire contact and the second electric wire contact has a curved surface groove formed with a curved surface matching a side surface shape of the electric wires for each of the electric wires.

4. The connector according to claim 3, wherein the curved surface groove has ribs partially press-fitted into a coating portion on an outer periphery of the electric wires when the first electric wire contact and the second electric wire contact clamp the electric wires.

5. The connector according to claim 4, wherein the ribs are provided for each curved surface groove in a circumferential direction of the curved surface of the curved surface groove.

6. The connector according to claim 4, wherein the ribs are formed for each curved surface groove in the second direction.

7. The connector according to claim 3, wherein the curved surface groove contacts each of the electric wires entirely with the curved surface.
